(19) United States
(12) Patent Application Publication
(10) Pub. No.: US 2006/0013581 A1
(43) Pub. Date: Jan. 19, 2006

(54) Photosensitive material processing apparatus

(75) Inventor: Futoshi Yoshida, Kanagawa (JP)

Correspondence Address: TAIYO CORPORATION, 401 HOLLAND LANE, #407, ALEXANDRIA, VA, 22314, US

(73) Assignee: FUJI PHOTO FILM CO., LTD.

(21) Appl. No.: 11/177,557

(22) Filed: Jul. 11, 2005

(30) Foreign Application Priority Data
Jul. 14, 2004 (JP) 2004-207399

(51) Int. Cl. G03D 3/08

(52) U.S. Cl. 396/614

(57) ABSTRACT

A liquid drop, which remains at a trailing end portion of a base surface side of a sheet which has passed through a roller pair, is removed by a first liquid drop removing roller which contacts only the base surface side. A spreading roller, which spreads moisture which has moved to a surface of the first liquid drop removing roller, is pressed to tightly contact the first liquid drop removing roller. A second liquid drop removing roller contacts only an emulsion surface of the sheet, and removes a liquid drop adhering to the emulsion surface. A spreading roller is pressed to tightly contact a surface of the second liquid drop removing roller as well, and spreads moisture at the surface thereof.

### CROSS-REFERENCE TO RELATED APPLICATION

This application claims priority under 35 USC 119 from Japanese Patent Application No. 2004-207399, the disclosure of which is incorporated by reference herein.

### BACKGROUND OF THE INVENTION

1. Field of the Invention

The present invention relates to a photosensitive material processing apparatus.

2. Description of the Related Art

After an image is recorded by exposure or the like onto a photosensitive material such as a photographic film, a photographic printing paper, or the like, the photosensitive material is processed by a photosensitive material processing apparatus. The photosensitive material processing apparatus has processing liquid processing sections, such as a developing tank, a fixing tank, a wash tank, and the like, and a drying section which dries the photosensitive material which has been processed in the processing liquid processing sections. Developing liquid, fixing liquid, and washing liquid are housed respectively in the processing tanks which are the developing tank, the fixing tank, and the wash tank.

While the photosensitive material, on which an image has been recorded, is conveyed through the developing tank, the fixing tank, and the wash tank in that order at the interior of the photosensitive material processing apparatus, the photosensitive material is immersed and processed in the developing liquid, the fixing liquid, and the washing liquid. The photosensitive material, for which processings have been completed in the processing liquid processing sections, is fed into the drying section, and is heated while being conveyed in the drying section such that moisture at the surfaces and within the photosensitive material is removed and the photosensitive material is dried.

In such a photosensitive material processing apparatus, in order for the photosensitive material, which has been processed in the processing liquid processing sections, to be efficiently dried without drying marks arising, plural pairs of squeeze rollers are provided between the processing liquid processing sections and the drying section. After the moisture adhering to the surfaces of the photosensitive material processed in the processing liquid processing sections is squeezed-out therefrom, the photosensitive material is conveyed into the drying section. Hardly any water drops are adhering to the surfaces of the photosensitive material which is conveyed into the drying section in this way. Therefore, at the drying section, it suffices to mainly remove the moisture within the photosensitive material, and drying processing can be carried out efficiently and in a short period of time, and the occurrence of drying marks due to water drops adhering to the surfaces of the photosensitive material can be prevented.

In recent years, in the field of processing photographic photosensitive materials, the demand to increase the speed of processing even more has become stronger. In accordance with this demand, studies are being carried out on processing liquids (developing liquids, fixing liquids, and the like) which enable the photosensitive material, such as a photographic film or the like, to be processed rapidly, and on photosensitive materials which can accommodate such rapid processing. Moreover, industries are waiting for the emergence of photosensitive material processing apparatuses which, by using such photosensitive materials and processing liquids which enable rapid processing, can shorten to 30 seconds or less the dry-to-dry time (the time from the start of processing of the photosensitive material to the end of drying) which conventionally reaches about 45 seconds.

However, when attempts are made to shorten the processing time in a photosensitive material processing apparatus, the time for each of the processings of developing, fixing, washing, and drying must be shortened. The processing times by the processing liquids such as the developing liquid, the fixing liquid, the washing liquid, and the like, can be shortened by, for example, shortening the length of the conveying path or increasing the conveying speed in each processing section, by using processing liquids which enable rapid processing as described above.

On the other hand, when shortening the processing time in the drying section, it suffices to increase the drying ability of the drying section by increasing the capacities of the heaters for applying heat to the photosensitive material, or the fans for blowing-out drying air, or the like. However, to this end, a large power source capacity is needed to operate the apparatus. Thus, how to efficiently carry out drying is being studied.

As a method of efficiently drying a photosensitive material, it is preferable to make the amount of moisture adhering to the surfaces of the photosensitive material which is conveyed into the drying section to be small, or to be uniform. To this end, a squeezing section is provided between the wash tank and the drying section in the photosensitive material processing apparatus. The photosensitive material, for which washing processing has been completed, is conveyed while being strongly nipped by plural roller pairs, and water drops adhering to the surfaces of the photosensitive material are squeezed-out. The photosensitive material is conveyed into the drying section while the water drops on the surfaces of the trailing end of the photosensitive material passing through the roller pairs are prevented from being carried-in (see, for example, Japanese Patent Application Laid-Open (JP-A) No. 07-036166, pages 4-5 and FIG. 2).

By sufficiently removing the water drops in this way from the surfaces of the photosensitive material which is being fed into the drying section, the photosensitive material can be dried by efficiently using the heaters within the drying chamber.

However, as shown in FIG. 3A, as a photosensitive material 102, which is nipped by a roller pair 100, passes through the roller pair 100, liquid pools 104 may form at the roller pair 100. This is the processing liquid which has been squeezed out from the photosensitive material 102 and remains on the surfaces of the roller pair 100 without being absorbed. When the photosensitive material 102 has passed through the roller pair 100 as shown in FIG. 3B, there are cases in which the processing liquid of the liquid pools 104 becomes liquid drops 106 and adheres to the trailing end portion of the photosensitive material 102, and is conveyed as is to the drying section.

Because the surface area of the processing liquid, which is adhering in the form of the liquid drops 106 in this way, is small, the dryability thereof is extremely poor. Depending on the case, even after the photosensitive material 102 passes through the drying section and drying processing is carried out, the photosensitive material 102 may be discharged with the processing liquid remaining adhered thereto. The print quality may deteriorate due to drying marks, or it may cause the problem of sticking.

This is particularly marked in a case in which an attempt is made to process the photosensitive material rapidly, because, due to a large amount of the photosensitive material being processed at high speed, the amount of processing liquid which is carried in by the photosensitive material is large, and the state, in which the processing liquid squeezed from the photosensitive material remains on the surfaces of the roller pair without being able to be completely absorbed, continues.

### SUMMARY OF THE INVENTION

In view of the aforementioned, an object of the present invention is to provide a photosensitive material processing apparatus having an excellent drying ability after processings such as developing, fixing, and the like.

A first aspect of the present invention is a photosensitive material processing apparatus having a squeezing section which, while nipping and conveying by a roller pair a photosensitive material which has been processed by a processing liquid, squeezes the photosensitive material and feeds the photosensitive material out to a drying section, wherein the squeezing section has a drying roller which contacts an emulsion surface of the photosensitive material at a conveying direction downstream side of the roller pair, and the drying roller has a hydrophilic surface and removes the processing liquid from the emulsion surface of the photosensitive material.

In the above-described first aspect, the processing liquid, which remains on the emulsion surface of the photosensitive material after developing processing, is removed by the drying roller which is provided within the squeezing section at a downstream region thereof. It is thereby possible to prevent drying imperfections, and the problem of the processed photosensitive material sticking, and the like.

A second aspect of the present invention is a photosensitive material processing apparatus having a squeezing section which, while nipping and conveying by a roller pair a photosensitive material which has been processed by a processing liquid, squeezes the photosensitive material and feeds the photosensitive material out to a drying section, wherein the squeezing section has a drying roller which contacts a base surface of the photosensitive material at a conveying direction downstream side of the roller pair, and the drying roller has a hydrophilic surface and removes the processing liquid from the base surface of the photosensitive material.

In the above-described second aspect, the processing liquid, which remains on the base surface of the photosensitive material after developing processing, is removed by the drying roller which is provided within the squeezing section at a downstream region thereof. It is thereby possible to prevent drying imperfections, and the problem of the processed photosensitive material sticking, and the like.

A third aspect of the present invention is a photosensitive material processing apparatus having a squeezing section which, while nipping and conveying by a roller pair a photosensitive material which has been processed by a processing liquid, squeezes the photosensitive material and feeds the photosensitive material out to a drying section, wherein the squeezing section has a first drying roller and a second drying roller, and at a conveying direction downstream side of the roller pair, the first drying roller contacts an emulsion surface of the photosensitive material and the second drying roller contacts a base surface of the photosensitive material, and the first drying roller and the second drying roller have hydrophilic surfaces and remove the processing liquid from the emulsion surface and the base surface, respectively, of the photosensitive material.

In the above-described third aspect, the processing liquid, which remains on the base surface and the emulsion surface of the photosensitive material after developing processing, is removed by the first drying roller and the second drying roller which are provided within the squeezing section at a downstream region thereof. It is thereby possible to prevent drying imperfections, and the problem of the processed photosensitive material sticking, and the like.

The photosensitive material processing apparatus of either of the above-described second and third aspects may have roller cleaning means for cleaning the drying roller which contacts the base surface of the photosensitive material.

In accordance with such a structure, by cleaning the drying roller which removes the processing liquid remaining on the base surface of the photosensitive material, dirtying of the drying roller is prevented, and dirtying of the base surface side of the photosensitive material can be prevented.

The photosensitive material processing apparatus of any of the above-described aspects may have a spreading roller which contacts the drying roller at a predetermined pressure. The spreading roller spreads, at the surface of the drying roller, the processing liquid which the drying roller removed from the surface of the photosensitive material.

In the photosensitive material processing apparatus of any of the above-described aspects, by making the spreading roller press-contact the drying roller, it is possible to prevent the surface of the drying roller from becoming saturated by the processing liquid removed from the photosensitive material, and drying imperfections of the photosensitive material can thereby be prevented. Further, by spreading the water drop of the surface of the roller, it is possible to prevent the water drop from re-adhering to the photosensitive material which comes in next.

The photosensitive material processing apparatus of any of the above-described aspects may have drying promoting means for guiding hot air from the drying section to the drying roller.

In accordance with such a structure, drying of the drying roller is promoted by the hot air from the drying section, and drying imperfections of the photosensitive material can be prevented.

A fourth aspect of the present invention is an apparatus for processing a sheet-shaped photosensitive material, the apparatus comprising: at least one roller pair which, while nipping therebetween and conveying a photosensitive material which has been subjected to liquid processing, squeezes processing liquid from the photosensitive material; and one roller which has a hydrophilic surface and which, at a conveying direction downstream side of the at least one roller pair, contacts one side surface of the photosensitive material in a state in which another side surface of the photosensitive material is free, thereby removing the processing liquid from the one side surface.

Because the present invention is structured as described above, the present invention can provide a photosensitive material processing apparatus having an excellent drying ability after developing and fixing processings.

### BRIEF DESCRIPTION OF THE DRAWINGS

FIG. 1 is a cross-sectional view showing a printer processor including a squeezing section relating to a first embodiment of the present invention;

FIG. 2 is a side view showing the squeezing section relating to the first embodiment of the present invention; and

FIGS. 3A and 3B are side views showing a conventional squeezing section.

### DETAILED DESCRIPTION OF THE INVENTION

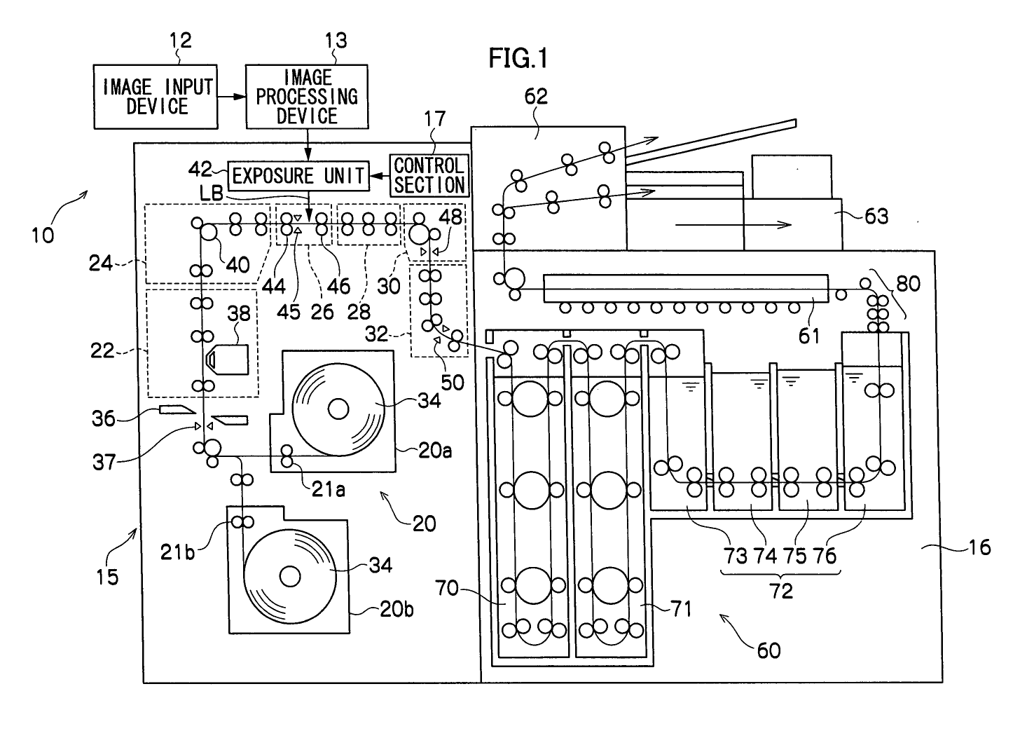

A printer processor using a sheet conveying device relating to a first embodiment of the present invention is shown in FIG. 1.

As shown in FIG. 1, a printer processor 10 has an image input device 12, an image processing device 13, a printer 15, and a processor 16. The respective portions structuring the printer processor 10 are connected to a control section 17 via wires (not shown), and the operation of the entire printer processor 10 is controlled by the control section 17.

The image input device 12 generates image data by photoelectrically reading-out, by using an image pickup element such as a CCD image sensor or the like, projected light of an image recorded on a photographic film. Or, the image input device 12 acquires image data by reading-out image data recorded on a recording medium such as a memory card or the like.

This image data is sent to the image processing device 13, and image processings such as color balance correction, density correction and the like are carried out. The image data which has been subjected to image processings is sent to the printer 15 and is used at the time of image recording which will be described later.

The printer 15, while conveying a sheet P which has been cut to a predetermined length, carries out image recording by exposure light which is intensity-modulated on the basis of the image data. The printer 15 has, from the upstream side in the conveying direction, a supplying section 20, a reverse side printing section 22, a registration section 24, an image recording section 26, a subscan receiving section 28, a distributing section 30, and a speed adjusting section 32. A plurality of conveying roller pairs, which are structured by a driving roller and a nip roller, are provided at each region along the conveying path of the sheet P.

Magazines 20a, 20b, which accommodate elongated photosensitive recording papers 34 which are each wound in the form of a roll, are set in the supplying section 20. Pull-out roller pairs 21a, 21b, which are for pulling the photosensitive recording papers 34 out and conveying them toward the reverse side printing section 22, are provided at the magazines 20a, 20b. In the present embodiment, the two magazines 20a, 20b are provided, but there may be one magazine or three or more magazines.

A cutter 36, which is for cutting the photosensitive recording paper 34, is provided at a position which is separated by a predetermined length from the exits of the magazines 20a, 20b. The cutter 36 is driven by receiving a control signal from the control section 17, and cuts the photosensitive recording paper 34, which has been conveyed-out by a predetermined length in accordance with the print size, so as to form the sheet P. Examples of the print size are L (89 mm×127 mm), panorama (89 mm×254 mm), 2L (127 mm×178 mm), whole plate (165 mm×216 mm), 8×10 inch (203 mm×254 mm), 10×12 inch (254 mm×305 mm), and the like. In the present embodiment, the printer processor 10 can handle sheets P whose print widths in the direction orthogonal to the conveying direction are, for example, 89, 95, 102, 117, 120, 127, 130, 152, 165, 178, 203, 210, 216, 254, 305 (units: mm).

The reverse side printing section 22 has a reverse side printing head 38 which records print information, such as the date of photographing the photograph, the date of printing, the frame number, various types of ID information, and the like, on the non-recording surface of the sheet P (the surface at the side opposite the exposure surface). A known printing head such as a dot impact head, an inkjet head, a heat transfer print head, or the like can be used as the reverse side printing head 38, provided that it is resistant to the wet-type developing processing which is carried out afterwards.

The image recording section 26 is structured by an exposure unit 42, subscanning roller pairs 44, 46, and a recording paper sensor 45 which detects the passage of the sheet P. The operation of the image recording section 26 is controlled by the control section 17. The exposure unit 42 is connected to the image processing device 13. When the recording paper sensor 45 detects that the leading end of the sheet P has passed by, the exposure unit 42 scans, in a main scanning direction (the direction orthogonal to the conveying direction) light beams LB of red, green and blue which have been intensity-modulated on the basis of the image data, so as to record an image on the sheet P. The subscanning roller pairs 44, 46, are disposed at the conveying direction upstream side and downstream side so as to sandwich the exposure position of the light beams LB, and convey the sheet P at a predetermined speed in a subscanning direction (the direction parallel to the conveying direction).

While conveying the sheets P, which are conveyed in a single row, at a predetermined first speed, i.e., the conveying speed in the printer, the distributing section 30 distributes the sheets P into two rows in the main scanning direction.

The speed adjusting section 32 conveys the sheets P, which are fed-in from the distributing section 30, at a second speed which corresponds to the processing speed of the processor 16, and sends the sheets P to the processor 16. A sensor portion 48 and a sensor portion 50, which are for detecting whether the sheet P is present or not, are provided in the distributing section 30 and the speed adjusting section 32, respectively. The sensor portions 48, 50 are, for example, optical sensors formed from a light-emitting diode and a photodiode, and the outputs thereof change when the sheet P passes by. In this way, the passing of the leading end or the trailing end of the sheet P can be detected.

The processor 16 is structured from a developing processing section 60, a squeezing section 80, a drying processing section 61, an allot-back section 62, and a sorter 63. A developing tank 70, a bleaching/fixing tank 71, and a wash tank 72 formed from a first wash tank 73, a second wash tank 74, a third wash tank 75, and a fourth wash tank 76, are provided in the developing processing section 60 in that order from the conveying direction upstream side. A predetermined amount of developing liquid is housed in the developing tank 70, a predetermined amount of bleaching/fixing liquid is housed in the bleaching/fixing tank 71, and predetermined amounts of wash water are housed in the first wash tank 73 through the fourth wash tank 76. The respective processings of developing, fixing, and washing are carried out due to the sheet P being conveyed through the interiors of the respective processing tanks 70 through 72, by receiving driving forces from conveying racks provided at the developing tank 70, the bleaching/fixing tank 71, and the first wash tank 73 through the fourth wash tank 76, respectively.

Before the sheet P, for which developing processing at the developing processing section 60 has been completed, is conveyed to the drying processing section 61, the remaining processing liquid is squeezed-out from the sheet P and the sheet P is set in a state in which liquid drops do not remain at the surfaces thereof, in a squeezing section 80 which will be described later. In this way, the sheet P which is conveyed in the drying processing section is dried uniformly and without irregularities.

The sheet P which has passed through the drying processing section 61 is fed toward the allot-back section 62. At the allot-back section 62, the sheets P which are being conveyed in two rows are allotted-back into a single row. The sorter 63 gathers together and outputs, per print job, the plural sheets P which have been fed from the allot-back section 62.

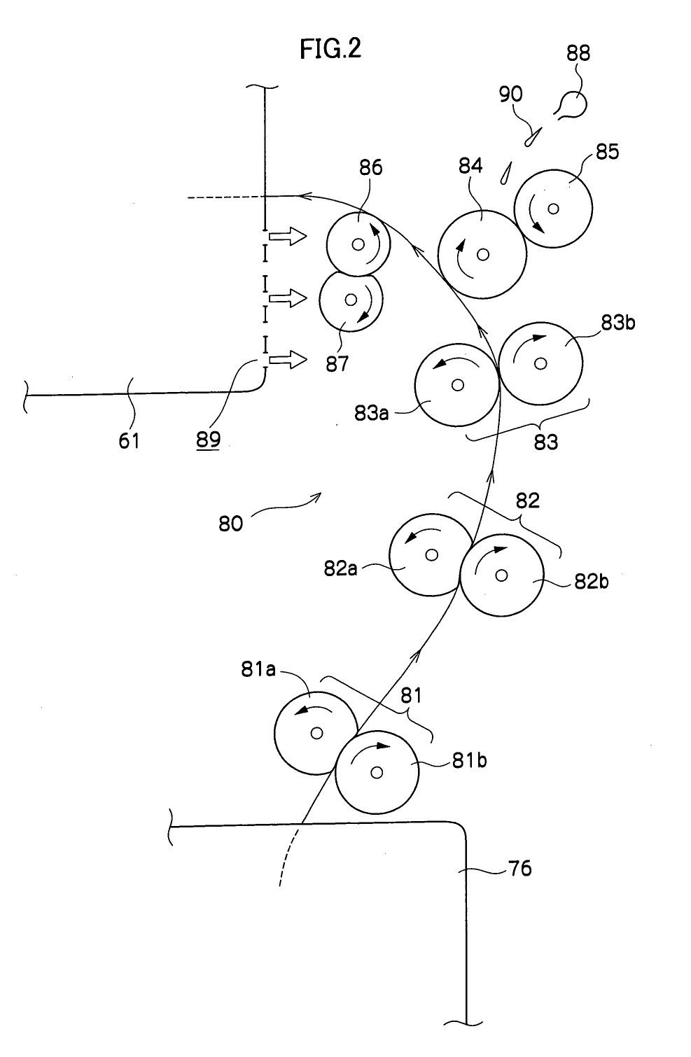

The squeezing section relating to the first embodiment of the present invention is shown in FIG. 2.

As shown in FIG. 2, during the period of time until the sheet P, for which processing is completed and which is conveyed from the fourth wash tank 76 in the directions of the arrows, reaches the drying processing section 61, the squeezing section 80 squeezes-out the residual processing liquid of the emulsion surface and the base surface, and conveys the sheet P to the drying processing section 61 in a state in which there is no moisture adhering to the surfaces of the sheet P in the form of liquid drops.

First, the sheet P, for which processing is completed and which is conveyed from the fourth wash tank 76, is nipped by a first stage roller pair 81, and the moisture remaining on the surfaces thereof is squeezed-out. A roller 81a at the emulsion surface side at this time (the left side in the drawing) is a soft roller such as a silicon rubber roller, and a roller 81b at the base surface side (the right side in the drawing) is a hard roller such as a paper phenol roller which has been subjected to a hydrophilic surface treatment.

When the soft roller and the hard roller oppose one another and are pressed to tightly contact one another (about 300 gf in this case), the soft roller 81a sinks-in, the surface area of contact with the hard roller 81b increases, and water drops can be efficiently removed from the sheet P. Further, the water drops, which have been squeezed-out once at the transverse direction both end portions and the trailing end portion of the sheet P which passes through the roller pair 81, can be prevented from passing between the roller pair 81 and being carried-in. In addition, because the surface of the hard roller 81b is hydrophilic, the water drop adhering to the surface of the sheet P can be removed uniformly. Moreover, by making the roller which is at the outer side of the conveying surface of the sheet P (i.e., at the base surface side, which is the right side in the drawing) a hard roller, the leading end of the sheet P is prevented from being thrust against the soft roller at a deep angle and being damaged, at the time when the sheet P is conveyed.

The sheet P which has passed through the first stage roller pair 81, is next nipped by a second stage roller pair 82, and the moisture remaining at the surfaces thereof is squeezed-out therefrom. In the same way as at the first stage, at the second stage roller pair 82 as well, a roller 82a at the emulsion surface side (the left side in the drawing) is a soft roller such as a silicon rubber roller, and a roller 82b at the base surface side (the right side in the drawing) is a hard roller such as a paper phenol roller which has been subjected to a hydrophilic surface treatment, and the rollers 82a, 82b are pressed to tightly contact one another at around 300 gf.

Because the liquid drops of the surfaces of the sheet P which has passed through the second stage roller pair 82 are made smaller, the sheet P passes through a third stage roller pair 83 which is structured by hard rollers in order to more uniformly squeeze-out the moisture at the surfaces. At the third stage roller pair 83, a roller 83a at the emulsion surface side (the left side in the drawing) and a roller 83b at the base surface side (the right side in the drawing) are both hard rollers such as paper phenol rollers which have been subjected to a hydrophilic surface treatment, and are pressed to tightly contact one another at around 300 gf. There is no press-contacting effect due to the elasticity of a soft roller, and instead, the moisture at the surfaces of the sheet P is uniformly extended by the two hard rollers and absorbed by the hydrophilic surfaces thereof. The moisture at the both surfaces of the sheet P is thereby removed efficiently.

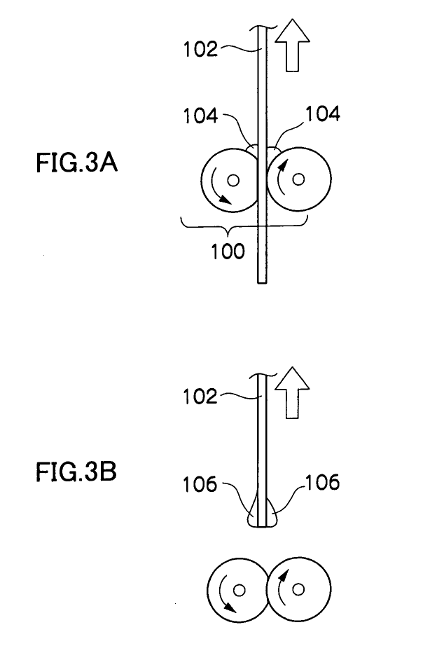

At this time, as described previously and as shown in FIG. 3A, there are cases in which the liquid pools 104 are formed at the roller pair 100 as the photosensitive material 102 nipped by the roller pair 100 passes through the roller pair 100. These are the processing liquid, which has been squeezed from the photosensitive material 102, remaining on the surfaces of the roller pair 100 without being completely absorbed. When the photosensitive material 102 has passed through the roller pair 100 as shown in FIG. 3B, there are cases in which the processing liquid of the liquid pools 104 becomes the liquid drops 106 and adheres to the trailing end portion of the photosensitive material 102, and is conveyed as is to the drying section.

In order to prevent such a situation, in the present embodiment, liquid drop removing rollers (drying rollers) which remove the liquid drops remaining on the sheet P are provided at the squeezing section.

Namely, the liquid drop remaining at the base surface side trailing end portion of the sheet P, which has passed through the third stage roller pair 83, is removed by a liquid drop removing roller (drying roller) 84. The liquid drop removing roller 84 is a hard roller such as a paper phenol roller which has been subjected to a hydrophilic surface treatment. The liquid drop removing roller 84 removes the liquid drop at the trailing end of the sheet P by contacting the base surface side without nipping the sheet P. An absorbent material such as a sponge has excellent absorbability of liquid drops, but also absorbs the residue of the processing liquid contained in the liquid drop, and therefore, the residue precipitates at the time of drying and becomes a cause of dirtying. By using a hard roller and not an absorbent material as the liquid drop removing roller 84, such dirtying can be prevented. Moreover, in a state in which the sheet P is not being conveyed, rinsing water 90 is jetted toward the liquid drop removing roller 84 from a nozzle 88 at a predetermined timing, so as to wash-off the dirt which has been transferred from the sheet P and has accumulated on the roller surface, so as to prevent the dirt from being retransferred to the sheet P.

In order to spread the moisture transferred to the surface of the liquid drop removing roller 84 and promote drying, and to prevent moisture from re-adhering from the liquid drop removing roller 84 to the base surface of the next sheet P which is conveyed-in, a spreading roller 85 is pressed to tightly contact the surface of the liquid drop removing roller 84 at about 150 gf. For the spreading roller 85 as well, a hard roller such as a paper phenol roller which has been subjected to a hydrophilic surface treatment is used, because cleaning efficiency would deteriorate if a soft roller such as a silicon rubber roller were used.

Next, a liquid drop removing roller (drying roller) 86, which is for removing the liquid drop adhering to the emulsion surface of the sheet P, contacts the emulsion surface of the sheet P. This liquid drop removing roller 86 also is a hard roller such as a paper phenol roller which has been subjected to a hydrophilic surface treatment, and removes the liquid drop at the trailing end of the sheet P by contacting the emulsion surface side without nipping the sheet P.

In order to spread the moisture transferred to the surface of the liquid drop removing roller 86 and promote drying, and to prevent moisture from re-adhering from the liquid drop removing roller 86 to the emulsion surface of the next sheet P which is conveyed-in, a spreading roller 87 is pressed to tightly contact the surface of the liquid drop removing roller 86 at about 150 gf. Because cleaning of the liquid drop removing roller 86 is not carried out, the spreading roller 87 may be a soft roller such as a silicon rubber roller or the like.

As shown in FIG. 2, air guiding ports 89 may be provided at the drying processing section 61 through which the sheet P, which has passed by the liquid drop removing rollers 84, 86, is conveyed, so that the hot air of the drying processing section 61 is guided to the squeezing section 80. The squeezing ability of the squeezing section 80 can be improved due to effects such as the vicinities of the liquid drop removing rollers 84, 86 and the roller pair 83 being heated by the heat of the drying processing section 61 and the heat being transferred from the surfaces of the respective rollers to the sheet P, or the evaporation of the moisture at the surfaces of the respective rollers being promoted by the heat.

In the above-described embodiment, the liquid drop removing rollers are provided at both the emulsion surface and the base surface of the sheet P. However, depending on settings such as the processing amount and the processing conditions and the like, effects can, of course, be anticipated even if the liquid drop removing roller is provided at only one side.

What is claimed is:

1. A photosensitive material processing apparatus having a squeezing section which, while nipping and conveying by a roller pair a photosensitive material which has been processed by a processing liquid, squeezes the photosensitive material and feeds the photosensitive material out to a drying section,
wherein the squeezing section has a drying roller which contacts an emulsion surface of the photosensitive material at a conveying direction downstream side of the roller pair, and the drying roller has a hydrophilic surface and removes the processing liquid from the emulsion surface of the photosensitive material.

2. The photosensitive material processing apparatus of claim 1, further comprising a spreading roller which contacts the drying roller at a predetermined pressure, the spreading roller spreading, at the surface of the drying roller, the processing liquid which the drying roller removed from the surface of the photosensitive material.

3. The photosensitive material processing apparatus of claim 1, wherein the drying section has drying promoting means for guiding hot air to the drying roller.

4. A photosensitive material processing apparatus having a squeezing section which, while nipping and conveying by a roller pair a photosensitive material which has been processed by a processing liquid, squeezes the photosensitive material and feeds the photosensitive material out to a drying section,
wherein the squeezing section has a drying roller which contacts a base surface of the photosensitive material at a conveying direction downstream side of the roller pair, and the drying roller has a hydrophilic surface and removes the processing liquid from the base surface of the photosensitive material.

5. The photosensitive material processing apparatus of claim 4, further comprising roller cleaning means for cleaning the drying roller which contacts the base surface of the photosensitive material.

6. The photosensitive material processing apparatus of claim 4, further comprising a spreading roller which contacts the drying roller at a predetermined pressure, the spreading roller spreading, at the surface of the drying roller, the processing liquid which the drying roller removed from the surface of the photosensitive material.

7. The photosensitive material processing apparatus of claim 4, wherein the drying section has drying promoting means for guiding hot air to the drying roller.

8. A photosensitive material processing apparatus having a squeezing section which, while nipping and conveying by a roller pair a photosensitive material which has been processed by a processing liquid, squeezes the photosensitive material and feeds the photosensitive material out to a drying section,
wherein the squeezing section has a first drying roller and a second drying roller, and at a conveying direction downstream side of the roller pair, the first drying roller contacts an emulsion surface of the photosensitive material and the second drying roller contacts a base surface of the photosensitive material, and the first drying roller and the second drying roller have hydrophilic surfaces and remove the processing liquid from the emulsion surface and the base surface, respectively, of the photosensitive material.

9. The photosensitive material processing apparatus of claim 8, further comprising roller cleaning means for cleaning the second drying roller.

10. The photosensitive material processing apparatus of claim 8, further comprising a spreading roller which contacts at least one of the first drying roller and the second drying roller at a predetermined pressure, the spreading roller spreading, at a surface of the at least one of the first drying roller and the second drying roller, the processing liquid which the at least one of the first drying roller and the second drying roller removed from the surface of the photosensitive material.

11. The photosensitive material processing apparatus of claim 8, wherein the drying section has drying promoting means for guiding hot air to the drying roller.

12. An apparatus for processing a sheet-shaped photosensitive material, the apparatus comprising:
at least one roller pair which, while nipping therebetween and conveying a photosensitive material which has been subjected to liquid processing, squeezes processing liquid from the photosensitive material; and
one roller which has a hydrophilic surface and which, at a conveying direction downstream side of the at least one roller pair, contacts one side surface of the photosensitive material in a state in which another side surface of the photosensitive material is free, thereby removing the processing liquid from the one side surface.

13. The apparatus for processing a sheet-shaped photosensitive material of claim 12, wherein the photosensitive material has an emulsion surface, and the one side surface is the emulsion surface.

14. The apparatus for processing a sheet-shaped photosensitive material of claim 12, wherein the photosensitive material has a base surface, and the one side surface is the base surface.

15. The apparatus for processing a sheet-shaped photosensitive material of claim 12, further comprising one other roller which has a hydrophilic surface and which, at a conveying direction downstream side of the roller, contacts only the other side surface of the photosensitive material in a state in which the one side surface of the photosensitive material is free, thereby removing the processing liquid from the other side surface.

16. The apparatus for processing a sheet-shaped photosensitive material of claim 14, further comprising a nozzle jetting rinsing water toward the roller.

17. The apparatus for processing a sheet-shaped photosensitive material of claim 12, further comprising a spreading roller which contacts the roller at a predetermined pressure, the spreading roller spreading, at the surface of the roller, the processing liquid which the roller removed from the one side surface of the photosensitive material.

18. The apparatus for processing a sheet-shaped photosensitive material of claim 12, further comprising hot air guiding means for guiding hot air to the roller.
